(19) United States
(12) Patent Application Publication
(10) Pub. No.: US 2018/0238264 A1
(43) Pub. Date: Aug. 23, 2018

(54) DIESEL PISTON WITH STEPPED BOWL

(71) Applicant: GM Global Technology Operations LLC, Detroit, MI (US)

(72) Inventors: Alberto Lorenzo VASSALLO, Torino (IT); Giuseppe GRIOLI, Torino (IT); Vincenzo PEZZA, Genova (IT)

(21) Appl. No.: 15/436,856

(22) Filed: Feb. 19, 2017

(51) Int. Cl. F02F 3/26

(52) U.S. Cl. CPC F02F 3/26

(57) ABSTRACT

A piston for a diesel engine, includes a piston body having a generally planar crown and a skirt extending from the crown. A stepped combustion bowl is recessed in the crown and includes an outer bowl recessed relative to the crown and an inner bowl recessed relative to the outer bowl.

### FIELD

The present disclosure relates to a diesel piston with a stepped bowl for improved emissions.

### BACKGROUND

This section provides background information related to the present disclosure which is not necessarily prior art.

It is known in the art relating to diesel engines that governmental emissions regulations require improvements in engine design in order to reduce emissions to meet or exceed these regulations. For example, enhanced air system designs could provide higher rates of cooled EGR (exhaust gas recirculation), thereby reducing NOₓ emissions, while enhanced fuel injection systems could reduce the inevitably higher soot emissions that would result from the use of higher EGR rates. Also, combined soot and NOₓ emissions after treatment systems could reduce emissions from diesel engines. Exhaust after treatment systems, however, can be costly and therefore are not the most desirable means of achieving emissions reductions.

In contrast, advancements in the combustion system design could reduce emissions while minimizing the need for costly and unproven diesel exhaust after treatment systems. Further, fuel economy, exhaust emissions, and performance of diesel combustion systems are greatly affected by the design of the engine's piston, as well as by the choice of fuel injection and air handling equipment (e.g., turbocharger, EGR system, etc.). Therefore, improvements in diesel engine piston design could advantageously lead to lower emissions without significant increases in cost.

### SUMMARY

This section provides a general summary of the disclosure, and is not a comprehensive disclosure of its full scope or all of its features.

The present invention provides an improved diesel engine combustion bowl design that allows for enhanced mixing of combustion products with excess air available in the cylinder, simultaneously reducing soot and NOₓ emissions. More particularly, the present invention provides a piston having an improved stepped bowl design. The improved stepped bowl design leads to a reduction in the production of NOₓ gases. The present disclosure also achieves superior trade-offs of soot (i.e., particulate matter) vs. NOₓ emissions and fuel consumption vs. NOₓ emissions.

According to the present disclosure, a piston for a diesel engine, includes a piston body having a generally planar crown and a skirt extending from the crown. A stepped combustion bowl is recessed in the crown and includes an outer bowl recessed relative to the crown and an inner bowl recessed relative to the outer bowl.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross-sectional view of a piston having a stepped combustion bowl disposed within a cylinder bore of an engine;

FIG. 2 is a perspective view of the piston having a stepped combustion bowl according to the principles of the present disclosure; and

FIG. 3 is a side cross-sectional view of a piston having a stepped combustion bowl according to the principles of the present disclosure.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

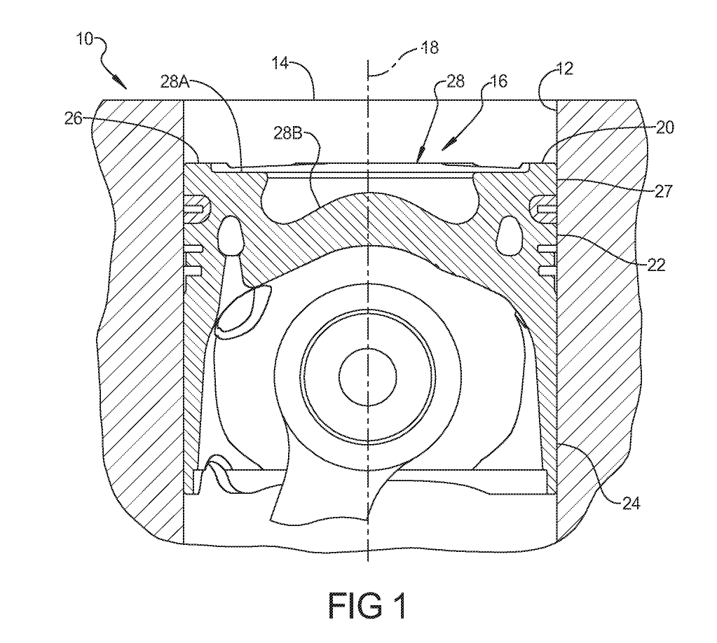

Referring first to FIG. 1 of the drawings, numeral 10 generally indicates a diesel engine including a cylinder 12 having a closed upper end 14. A piston 16 is reciprocable in the cylinder 12 along a central axis 18. The piston 16 generally has a cylindrical shape centered on the axis 18 and includes a crown 20, a ring belt 22 with piston ring grooves and a skirt 24 extending axially from the ring belt 22. The crown 20 has a generally planar upper rim 26 extending inward from a side wall 27 and generally defining the top of the piston 16. A stepped circular combustion bowl 28 is recessed in the crown 20 within the crown rim 26 and centered on the central axis 18.

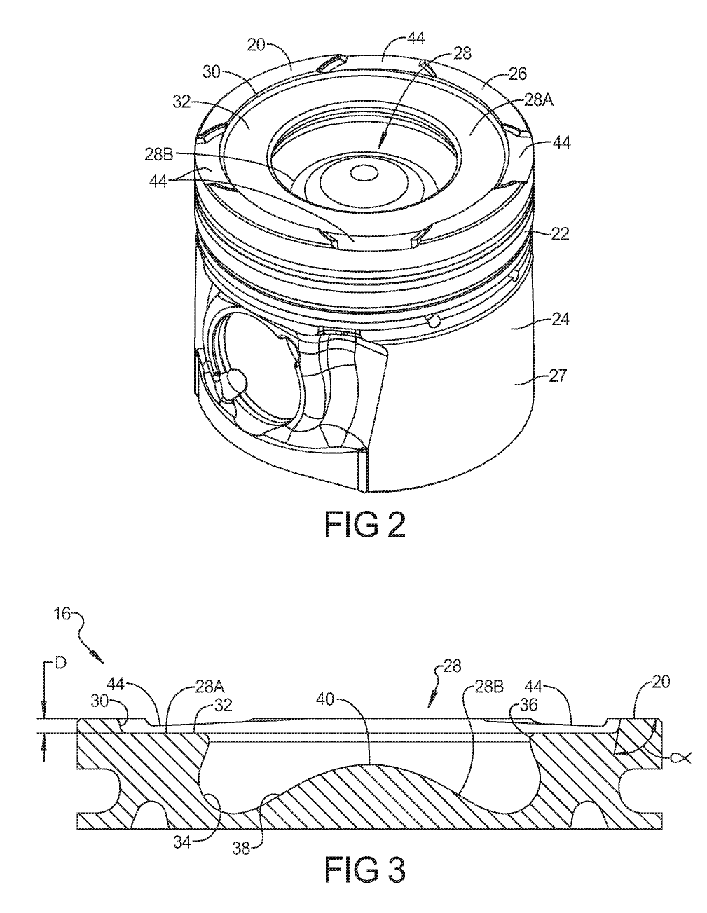

With reference to FIGS. 2 and 3, the stepped circular combustion bowl 28 includes an outer bowl 28A and an inner bowl 28B. The outer bowl 28A is recessed from the crown 20 at a generally constant step depth D and includes a circular outer wall 30 that is angled radially inward at an angle a with respect to the crown 20. The depth D can be between 1 and 4 mm. The angle a can be between 90° and 135°. The outer bowl 28A includes a bottom surface 32 that extends radially inward from the outer wall 30. The inner bowl 28B is recessed relative to the bottom surface 32 of the outer bowl 28A and has an arcuate annular outer wall 34 that curves radially outward from an upper edge 36 and transitions radially inward with a bottom surface 38 with a mounded center region 40. The inner bowl 28B has a maximum depth relative to the outer bowl 28A of between 8 to 12 mm. The mounded center region 40 can be raised relative to the bottom-most surface of the inner bowl by between 6 and 9 mm. The crown 20 of the piston 16 can further include a plurality of radially outwardly extending reliefs 44. The reliefs 44 can be equally spaced and have sidewalls 46 that narrow the reliefs 44 as the reliefs extend radially outward. The fuel sprayed from a fuel injector (not shown) is sprayed from the central axis 18 out toward the annular outer wall 34 of the inner bowl 28B.

The stepped bowl design 28 is axisymmetric and therefore, it is only necessary to show the configuration of the bowl 36 to the right or left of the center axis 18 to illustrate the shape of the stepped bowl design 28. The three-dimensional configuration of the stepped combustion bowl 28 can be obtained by rotating the cross-sectional view of FIG. 1 360 degrees about the center axis 18.

The improved design of the stepped combustion bowl 28 achieves simultaneous reduction of soot and NOₓ emissions by providing enhanced mixing of combustion products with excess air available in the cylinder. Further, the stepped combustion bowl 28 achieves this reduction of soot and NOₓ emissions while also maintaining or improving fuel consumption using conventional fuel injection and air handling equipment. Moreover, the stepped combustion bowl 28 may potentially increase power density through the reduction of soot emissions, thereby allowing for higher fueling rates while still meeting governmentally mandated soot emission levels. The outer wall 30 of the outer bowl 28A limits excessive spray penetration at high load. The stepped combustion bowl 28 of the present disclosure also advantageously achieves these benefits without additional costs.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A piston for a diesel engine, comprising:
a piston body having a generally planar crown and a skirt extending from the crown; and
a stepped combustion bowl recessed in the crown, the stepped combustion bowl having an outer bowl recessed relative to the crown and an inner bowl recessed relative to the outer bowl.

2. The piston according to claim 1, wherein the outer bowl has an annular outer wall that is angled relative to the crown.

3. The piston according to claim 2, wherein annular outer wall of the outer bowl is angled relative to the crown by an angle of between 90° and 135°.

4. The piston according to claim 1, wherein the outer bowl has a generally planar bottom surface with a depth relative to the crown of between 1 and 5 mm.

5. The piston according to claim 1, wherein the inner bowl has a maximum depth relative to the outer bowl of between 8 to 12 mm.

6. The piston according to claim 5, wherein the inner bowl has a mounded center region.

7. The piston according to claim 6, wherein the mounded center region is raised relative to the maximum depth of the inner bowl by between 6 and 9 mm.

8. The piston according to claim 1, wherein the inner bowl has an arcuate annular outer wall that has an upper edge transitioning from a bottom surface of the outer bowl and extending radially outward.

9. The piston according to claim 1, wherein the crown includes a plurality of radially extending reliefs extending from the stepped combustion bowl to an outer edge of the piston.

10. The piston according to claim 9, wherein the reliefs include a pair of sidewalls and the reliefs narrow in a radial outward direction.

11. A piston for a diesel engine, comprising:
a piston body having a generally planar crown and a skirt extending from the crown; and
a stepped combustion bowl recessed in the crown, the stepped combustion bowl having an outer bowl recessed relative to the crown and an inner bowl recessed relative to the outer bowl, wherein the outer bowl has an annular outer wall that is angled relative to the crown, wherein the outer bowl has a generally planar bottom surface with a depth relative to the crown of between 1 and 5 mm.

12. The piston according to claim 9, wherein annular outer wall of the outer bowl is angled relative to the crown by an angle of between 90° and 135°.

13. The piston according to claim 9, wherein the inner bowl has a maximum depth relative to the outer bowl of between 8 to 12 mm.

14. The piston according to claim 11, wherein the inner bowl has a mounded center region.

15. The piston according to claim 11, wherein the mounded center region is raised relative to the maximum depth of the inner bowl by between 6 and 9 mm.

16. The piston according to claim 9, wherein the inner bowl has an arcuate annular outer wall that has an upper edge transitioning from a bottom surface of the outer bowl and extending radially outward.

17. The piston according to claim 9, wherein the crown includes a plurality of radially extending reliefs extending from the stepped combustion bowl to an outer edge of the piston.

18. The piston according to claim 18, wherein the reliefs include a pair of sidewalls and the reliefs narrow in a radial outward direction.
